(19) United States
(12) Patent Application Publication
(10) Pub. No.: US 2015/0134523 A1
(43) Pub. Date: May 14, 2015

(54) TELEPHONE ORDER PAYMENTS AUTHENTICATION USING PHONE NUMBER RECOGNITION

(71) Applicant: MasterCard International Incorporated, Purchase, NY (US)

(72) Inventor: Justin Xavier Howe, Oakdale, NY (US)

(73) Assignee: MasterCard International Incorporated, Purchase, NY (US)

(21) Appl. No.: 14/077,639

(22) Filed: Nov. 12, 2013

(51) Int. Cl. G06Q 20/30; G06Q 20/40

(52) U.S. Cl. CPC G06Q 20/305; G06Q 20/40
USPC 705/44

(57) ABSTRACT

Presented are a method, system, and software product for transaction authentication via identification of a received telephone call. A telephone call is received from a potential payor requesting payment instrument transaction authorization. A determination is made via the telephone company of whether the telephone number was engaged in a call mode when the telephone call was received. If so, the transaction is allowed to proceed. Also presented are a method, system, and software product for authorization of transactions made via telephone. A payment instrument organization receives a request for transaction authorization containing a unique customer identifier of a customer attempting to complete a transaction via telephone. The associated telephone company is then contacted to determine whether the customer telephone number was engaged in an outbound call at the time the request for authorization of the transaction was received. If so, the transaction is approved.

### CROSS-REFERENCE TO RELATED APPLICATIONS

This application is related to U.S. patent application Ser. No. 13/457,701, “Method for Providing Payment Card Security Using Registrationless Telecom Geolocation Capture,” by Justin X. Howe and Randall K. Shuken. The complete disclosure of the application is incorporated by reference in its entirety.

### BACKGROUND

1. Field of the Disclosure

The present disclosure relates to electronic transaction processing. More specifically, the present disclosure is directed to an improved method, system, and computer software product for the authentication of telephone bill payments and telephone orders.

2. Background of the Disclosure

The payment industry, which enables the use of payment instruments, is presented with the constant challenge of preventing fraudulent transactions, and resolving a fraudulent transaction if it does occur. In 2012, the value of gross fraud in payment instruments led to total losses of $11.27 billion, up 14.6% from 2011. “Global Credit, Debit, and Prepaid Card Fraud Losses Reach $11.27 Billion in 2012—Up 14.6% Over 2011 According to the Nilson Report,” REUTERS, available at http://www.reuters.com/article/2013/08/19/ca-nilson-report-idUSnBw195953a+100+BSW20130819 (last visited Oct. 21, 2013).

Telephone transactions, in particular, along with e-commerce and mail order transactions, present an enormous difficulty for fraud prevention because the merchant or other payment recipient is unable to physically inspect a payment instrument, and therefore cannot easily confirm whether the true payment instrument holder is approving the transaction. These transactions are collectively referred to as “card-not-present” (or “CNP”) transactions. Most losses suffered by individuals and payment instrument institutions occur via CNP transactions. “Global Credit, Debit, and Prepaid Card Fraud Losses Reach $11.27 Billion in 2012—Up 14.6% Over 2011 According to the Nilson Report,” REUTERS, available at http://www.reuters.com/article/2013/08/19/ca-nilson-report-idUSnBw195953a+100+BSW20130819 (last visited Oct. 21, 2013). Completion of transactions via telephone, payment of bills via telephone, or other transaction payment processing via telephone is, however, a desirable feature made possible by the use of payment instruments. Customers enjoy being able to simply call a merchant, order a good or service, pay for it on the same telephone call, and receive it in a few days. Similarly, quickly paying bills via telephone is facilitated by telephone payment processing using a payment instrument.

Accordingly, there is a need for a method, system, and computer software product which offers a means of preventing fraud in CNP transactions occurring via telephone.

### SUMMARY OF THE DISCLOSURE

Disclosed is a method, system, and computer software product for authentication of a transaction by a payment instrument via identification of a telephone call received by a call center. A call center receives a telephone call from a potential payor requesting authorization of a payment transaction by a payment instrument. In an embodiment of the disclosure, the payment transaction is a telephone payment or a telephone order. Non-limiting examples of types of payment transactions include payment for a good or service, payment for an insurance premium, payment for a mortgage, or payment for a revolving account associated with a payment instrument. In a further embodiment of the disclosure, the call center is maintained by a payment instrument issuer, a merchant acquiring bank, a merchant service provider, a payment instrument network and/or a merchant.

A computing device associated with the call center stores a telephone number associated with the received telephone call and a time the received telephone call was received at the call center in a data structure. The computing device then determines which telephone company of a plurality of telephone companies is associated with the telephone number of the received telephone call.

A query is then transmitted by the computing device to the identified telephone company associated with the received telephone call. A Boolean response is then received from the identified telephone company indicating whether or not the telephone number associated with the received telephone call contained in the data structure was engaged in an outbound call at the time the received telephone call was received at the call center. If the Boolean response received from the identified telephone company indicates true, the further steps are performed of retrieving a payment instrument identification of one or multiple payment instrument identifications associated with the potential payor from a computer database and allowing authorization of the transaction to proceed. In an embodiment of the disclosure, if the Boolean response from the telephone company indicates true and if multiple payment instrument identifications are associated with the potential payor, an option is automatically presented of which payment instrument identification to utilize to the potential payor previous to allowing authorization of the transaction to proceed. An option of which payment instrument identification to utilize is presented to the potential payor to make a selection of which payment instrument identification to utilize to complete the transaction. The presentation can be made via an interactive voice menu, an automated attendant, a menu allowing a teletype prompt, text message, e-mail message, internet address re-direct, or any other currently existing or after-arising means. Else if the Boolean response from the identified telephone company indicates false, the further step is performed of automatically informing the potential payor of a failure to authenticate the transaction.

Also disclosed is a method, system, and computer software product for authorization of payment instrument transactions made via telephone. A payment instrument organization receives a request for authorization of a transaction containing a customer identification number or a payment instrument identification, either uniquely identifying a potential payor attempting to complete a transaction via telephone. In an embodiment of the disclosure, the payment instrument organization is selectively one of a payment instrument issuer, a merchant acquiring bank, a merchant service provider, and a payment instrument network.

A database maintained by the payment instrument organization is then accessed to obtain a customer telephone number associated with the potential payor. A computing device associated with the payment instrument organization the customer telephone number associated with the potential payor and a time the request for authorization of the transaction was received by the payment instrument organization in a data structure. The computing device then identifies which telephone company of a plurality of telephone companies is associated with the customer telephone number. A query including the data structure is transmitted by the computing device to the identified telephone company associated with the customer telephone number.

The computing device then receives a response containing a Boolean response from the identified telephone company indicating whether or not the customer telephone number associated with the potential payor was engaged in an outbound call within a window of time of when the request for authorization of the transaction was received. If the Boolean response is true, the response further contains a destination number the potential payor was in contact with within the window of the time of when the request for authorization was received, and performing the further step of approving the transaction. In a further embodiment of the present disclosure, if the Boolean response is true, the further step is performed of updating a merchant database associating an identification of the merchant (such as the name, address, products sold, or other data point regarding a merchant) with the destination telephone number the potential payor was in contact with within the window of time of when the request for authorization was received. Maintenance of such a database has numerous advantages in the terms of data mining. If the Boolean response is false, the further step is performed of denying the transaction.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 is a block diagram, illustrating a cycle for payment instrument transaction processing.

FIG. 2 is a flowchart describing a process for completion of a payment instrument transaction, in an embodiment of the disclosure.

FIG. 3 is a flowchart describing a process for authorization of a payment instrument transaction, in an embodiment of the disclosure.

FIG. 4 is a schematic diagram displaying elements utilized in the process of completion of payment transactions, in an embodiment of the disclosure.

FIG. 5 is a block diagram of a system for authorization of payment instrument transactions, in an embodiment of the disclosure.

### DETAILED DESCRIPTION

The following sections describe exemplary embodiments of the present disclosure. It should be apparent to those skilled in the art that the described embodiments of the present disclosure are illustrative only and not limiting, having been presented by way of example only. All features disclosed in this description may be replaced by alternative features serving the same or similar purpose, unless expressly stated otherwise. Therefore, numerous other embodiments of the modification thereof are contemplated as falling within the scope of the present disclosure as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

The present disclosure is described below with reference to flowchart illustrations and/or block diagrams of methods, systems, and computer program products according to embodiments of the disclosure. It will be understood that each block of the flowchart illustrations and/or block diagrams, and combinations of blocks in the flowchart illustrations and/or block diagrams, may be implemented by computer program instructions.

As will be appreciated by one skilled in the art, the present disclosure may be embodied as a system, method, or computer program product. Accordingly, the present disclosure may take the form of an entirely hardware embodiment, an entirely software embodiment (including firmware, resident software, micro-code, etc.) or an embodiment combining software and hardware aspects that may generally be referred to herein as a “server,” “device,” “computing device,” “computer device,” or “system.” As is commonly known in the art, such devices are associated with a single or multiple processors or CPUs, which are specially programmed in order to perform a task at hand. Multiple computer systems can also be networked together in a local-area network or via the internet to perform the same function. Furthermore, the present disclosure may take the form of a computer program product embodied in any tangible medium of expression having computer usable program code embodied in the medium. Computer program code for carrying out operations of the present disclosure may operate on any or all of a “server,” “computing device,” “computer device,” or “system” discussed herein. Computer program code for carrying out operations of the present disclosure may be written in any combination of one or more programming languages, including an object-oriented programming language such as Java, Smalltalk, C++, or the like and/or conventional procedural programming languages, such as Visual Basic, “C,” or similar programming languages. After-arising programming languages are contemplated as well.

These computer program instructions may be provided to a processor of any “computing system,” or “computing device,” including a server, general purpose computer, special purpose computer, tablet pc, mobile telephone, embedded system, or any other programmable data processing apparatus to produce a machine, such that the instructions, which execute via the processor of the computer or other programmable data processing apparatus, create means for implementing the functions/acts specified in the flowchart(s), block diagram block(s), or any other figures herein. These computer programmable instructions may also be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer device or other programmable apparatus to produce a computer-implemented process such that the instructions which execute on the computer device or other programmable apparatus provide processes for implementing the functions/acts specified in the flowchart(s), block diagram block(s), or any other figures herein.

As used for the purposes of the presently disclosed method, system, and computer software product alone (unless specified otherwise), the term “data structure” refers to a computer-based storage unit allowing for the storage of single or multiple types of data. The data structure may take the form of any computer-based storage unit at any level of an OSI model, including objects, classes, linked-lists, tree structures, matrices (as defined in various programming languages), arrays, variables, text files, SQL-databases or database entries, spreadsheets or spreadsheet entries, packets, frames, or any presently existing or after-arising equivalent allowing computer-based storage and/or transmission of data. The “data structure” for the purposes defined herein can actually be one or multiple computer-storage units transmitted sequentially or in parallel.

As used for the purposes of the presently disclosed method, system, and computer software product alone (unless specified otherwise), the term “payment instrument” refers to credit cards, debit cards, prepaid cards, electronic wallets, software-enabled smartphones, transponder devices, near-field communication-enabled (“NFC”) smartphones, (or similar presently existing or after-arising technology) allowing the payment instrument holder to use the payment instrument as a system of payment for goods, services, bills, etc. based upon the payment instrument holder's promise to pay for such goods, services, cash advances, etc., in the future, typically via a revolving account. A “payment instrument identification” is a unique numeric, alpha-numeric, or alphabetical identification unique to every payment instrument to identify the account associated with the payment instrument, and therefore aid in accepting payments from customers and making payments to merchants, etc. A non-limiting example of a “payment instrument identification” is the 16 digit credit number on a credit card, formatted in accordance with ISO/EIC 7812. ISO/EIC 7812 is incorporated herein in its entirety.

As used for the purposes of the presently disclosed method, system, and computer software product alone (unless specified otherwise), the term, “telephone company” refers to any provider of voice or data service to a subscriber, customer, or any other individual or organization whether via a traditional circuit-switched network, via a packet-switched network, via a provider of internet service, or any other electrical, optical, or electromagnetic means presently existing or after-arising technology that allows an individual or group at a transmitting side to speak, teletype, transmit e-mail, text message, or otherwise communicate with another individual, group, or other non-human recipient at the receiving side. Non-limiting examples of “telephone companies” include examples that were historically circuit-switched such as common carriers, local exchange carriers, telephone service providers, etc. as well as more modern digital and/or packet-switched examples, such as internet telephony service providers, cellular service providers, satellite phone providers and even internet service providers. Traditionally, a first party to a telephone call “dials” a second party, and is engaged in an “outbound call,” while the second party is simultaneously receiving an “inbound call.”

As used for the purposes of the presently disclosed method, system, and computer software product alone (unless specified otherwise), the terms “spoof” or “spoofing” refers to a deliberate attempt to falsify the origination number of a telephone call, particularly to defeat a caller ID system, calling line identification system, calling number delivery system, calling number identification system, or any other phone number identification means associated with a recipient of the telephone call.

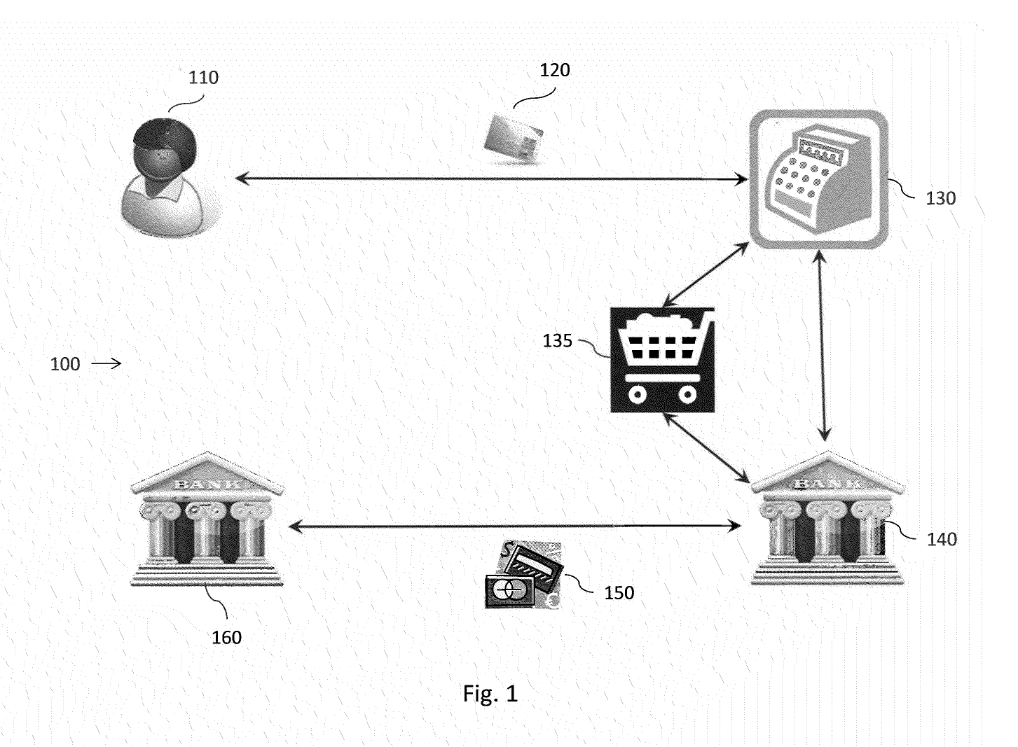

Referring now to FIG. 1, illustrated is a block diagram 100 displaying the general process of the completion of a payment instrument transaction with a payment instrument in an embodiment of the disclosure. A customer (also known as a payment instrument holder) 110 desires to purchase a good or service from a merchant 130. Customer 110 presents a payment instrument 120 (such as a credit card, debit card, prepaid card, ATM card, CHIP card, electronic wallet, transponder device, NFC-enabled smart phone, PIN transaction, or similar current or after-arising technology) to the merchant 130 for payment in connection with a payment transaction. The merchant 130 utilizes his or her transaction acquiring device (not shown) to communicate with a merchant acquiring institution or “Acquirer” 140 seeking approval for this transaction. Alternately, the merchant 130 seeking approval for a transaction may route through a “merchant service providers,” 135 (also known as a “payment facilitator”). The merchant service provider/payment facilitator (such as, by means of non-limiting example, PayPal, Square, iZettle, and others) handle the relationship between the Acquirer 140 and the merchant 130 (as by depositing funds in a merchant's 130 account, batching settlements, etc.). The Acquirer 140 transmits an authorization message formatted pursuant to ISO 8583 (which is incorporated here in its entirety) or its present or after-arising equivalent. The transmission is made via a payment instrument network 150 to a payment instrument issuing institution 160 associated with the payment instrument 120. Should approval be appropriate, the payment instrument issuing institution 160 transmits an approval message via the payment instrument network 150 to the Acquirer 140 who then retransmits the approval message to the merchant 130, who thusly learns the transaction has been approved. As previously discussed, the approval message is transmitted in formatting consistent with ISO 8583 or its present or after-arising equivalent.

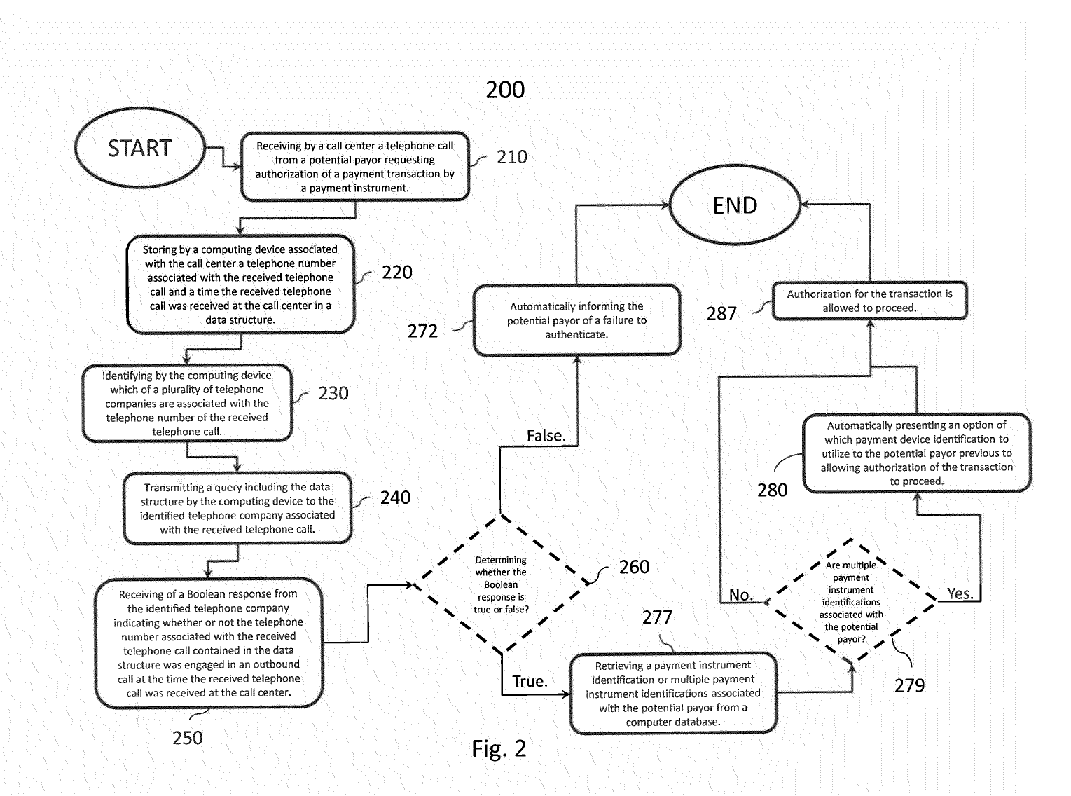

Referring now to FIG. 2, illustrated is a flowchart, 200, describing a process for authenticating a transaction to be completed with a payment instrument via identification of a telephone call received at a call center in an embodiment of the disclosure. At step 210, a call center receives a telephone call from a potential payor requesting authorization of a payment transaction by a payment instrument. In an embodiment of the disclosure, the call center is operated by, maintained by, or services a payment instrument issuer, a merchant acquiring bank, a payment instrument network, or one or a plurality of merchants. In other embodiments, the call center is operated by any other individual or organization such as, by way of non-limiting example, a merchant, a utility company, a cable company, or any other individual or organization requiring quick payment for goods or services via use of a payment instrument identification previously stored in a computer database. The call center may even accept payments from customers for settling of their payment instrument accounts. At step 220, a computing device associated with the call center stores a telephone number associated with the received telephone call and a time the received telephone call was received at the call center in a data structure. The telephone number and the time the received telephone call was received are used in the process of authentication of the telephone transaction, as described below. At step 230, in an embodiment of the disclosure, the computing device accesses a database containing information regarding which telephone company of a plurality of telephone companies is associated with the telephone number of the received telephone call. In various embodiments of the disclosure, the database is maintained by the same organization or individual that maintains the call center, and in other embodiments the database is maintained remotely by a third-party (such as a by a phone company, a plurality of phone companies, or a government organization). The database is available locally or via the internet, a network, or other computerized connection. Once the telephone company is identified, at step 240 a query is transmitted by the computing device to the identified telephone company associated with the received telephone call. The query may include the previously generated data structure containing the telephone number associated with the received telephone call and the time the call was received at the call center. In practice, the query may take the form of a data stream or any other computer-generated form (such as by way of non-limiting example, a datagram, a remote function call, an e-mail, or any other presently existing or after-arising method for transmitting information between computers and/or computing devices). In a further embodiment of the disclosure, the data structure is transmitted separately from the query.

At step 250, a Boolean response is received from the identified telephone company indicating whether or not the telephone number associated with the received telephone call contained in the data structure was engaged in an outbound call at the time the received telephone call was received at the call center. The Boolean response may take the form of a true-false response, a 1-0, or any presently-existing or after-arising equivalent allowing a response to the query of step 240. This prevents traditional telephone number “spoofing,” from being used to deceive the operator of the call center from accepting payments from an individual other than the true holder of the payment instrument identification and allows authentication based on an incoming telephone number. In order to thwart criminals from trying to further defeat the system, method, and computer software product as described in the present disclosure from simply calling the phone number of the potential payor when attempting to make a payment, the telephone company determines not whether the call was simply pending, but rather, whether the call was in an outbound call mode or dial-mode. At step 260 the computing device associated with the call center determines whether or not the Boolean response indicates “true” or “false.” If the Boolean response is false, at step 272, the potential payor is automatically informed of a failure to authenticate. If the Boolean response is true, at step 277 a payment instrument of one or multiple payment instrument identifications associated with the potential payor is retrieved from a computer database. The payment instrument identification or multiple payment instrument identifications associated with the potential payor were previously associated to facilitate making a payment via telephone.

In an embodiment of the disclosure, at step 279 a determination is made whether multiple payment instrument identifications are associated with the potential payor. If there are multiple payment identifications associated with a potential payor, at step 280, an option is automatically presented of which payment instrument identification to utilize to the potential payor previous to allowing the transaction to proceed. In various embodiments of the disclosure, an interactive voice response (“IVR”) menu is provided allowing menu selection via voice or dual-tone multi-frequency signaling/touch-tone dialing of the potential payor. In other embodiments, an automated attendant, a menu allowing a teletype prompt, text message, e-mail message, internet address re-direct, or any other currently existing or after-arising means are presented to the potential payor to make a selection of which payment instrument identification to utilize to complete the transaction. At step 287, (in an embodiment of the disclosure) authorization for the transaction is allowed to proceed. The correct payment instrument account is billed, etc. In either case, after step 287, execution terminates.

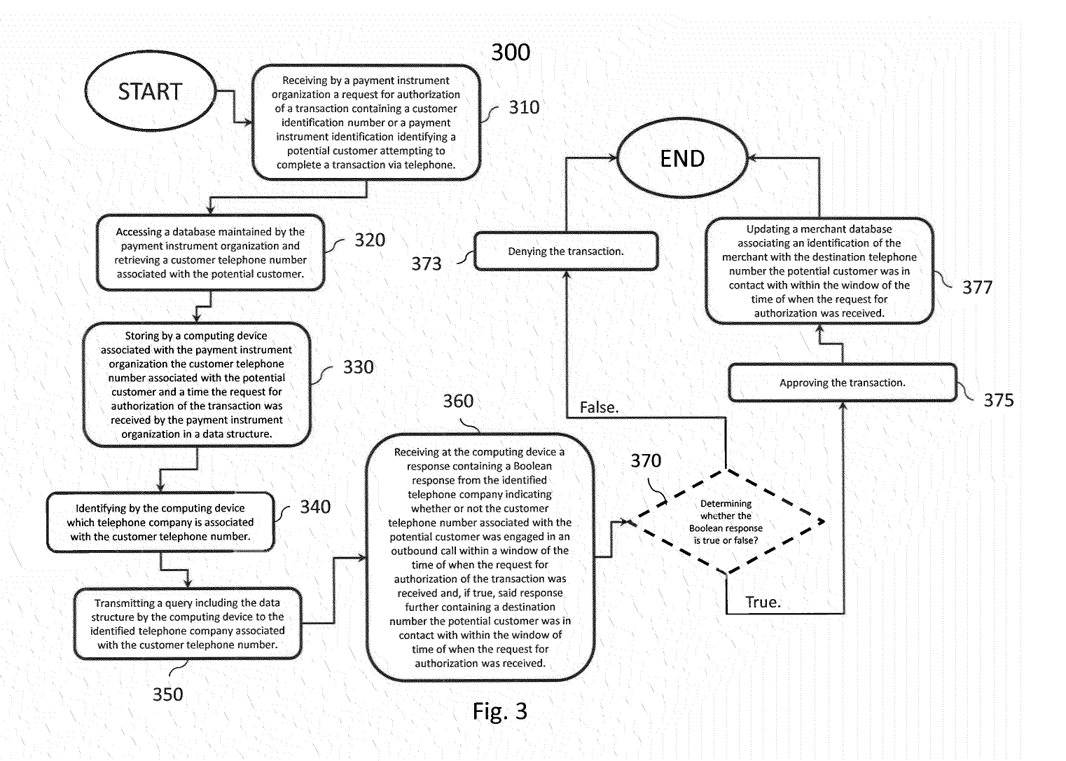

Referring now to FIG. 3, illustrated is a flowchart, 300 describing a process for authorization of payment instrument transactions made via a telephone in an embodiment of the disclosure. Described in FIG. 3 is a process by which an external individual or organization receives a request for payment by telephone of a bill, good, or service, and where a payment instrument is utilized. FIG. 3 presents a process whereby a payment instrument organization decides whether or not to authenticate the requested transaction requested by the external individual or organization. This disclosed process is utilized as a fraud prevention measure by a payment instrument organization processing these types of payments. At step 310, a payment instrument organization receives a request for authorization of a transaction containing a customer identification number uniquely identifying a potential payor attempting to complete a transaction via telephone. In embodiments of the disclosure, the payment instrument organization is selectively one of the following: a payment instrument issuer, a merchant acquiring bank, a merchant service provider, and a payment instrument network. In alternate embodiments, a payment instrument identification utilized to attempt to complete a transaction is transmitted alternately or in addition to the customer identification number. The payment instrument identification also uniquely identifies a potential payor. At step 320, a database maintained by the payment instrument organization is accessed and a customer telephone number associated with the potential payor is retrieved. At step 330, a computing device associated with the payment instrument organization stores the customer telephone number associated with the potential payor and a time the request for authorization of the transaction was received by the payment instrument organization in a data structure. At step 340, the computing device identifies which telephone company of a plurality of telephone companies is associated with the customer telephone number. At step 350, a query including the data structure is transmitted by the computing device to the identified telephone company associated with the customer telephone number. In alternate embodiments, the query is transmitted separately or in the alternate to the data structure. At step 360, the computing device receives a response containing a Boolean response from the identified telephone company indicating whether or not the customer telephone number associated with the potential payor was engaged in an outbound call within a window of the time of when the request for authorization of the transaction was received and, if true, the response further containing a destination number the potential payor was in contact with within the window of time of when the request for authorization was received. In alternate embodiments, the response, Boolean response, and destination number are transmitted separately or in any order. At step 370, a determination is made by the computing device whether or not the Boolean response indicates “true” or “false.” As previously indicated, the Boolean response may take the form of a true-false response, a 1-0, or any presently-existing or after-arising equivalent. If the Boolean response indicates false, at step 373 the transaction is denied. If the Boolean response indicates true, at step 375 the transaction is approved. In either event, the external individual or organization is informed whether or not the transaction is approved.

According to another aspect of the disclosure, at step 377 a merchant database associating an identification of the merchant (such as the merchant name, numeric identification, alphanumeric identification, or any other identification uniquely identifying the merchant in the merchant database) is updated with the destination telephone number the potential payor was in contact with within the window of time of when the request for authorization was received. In an embodiment of the disclosure, the merchant database is maintained by one of the payment instrument issuer, the merchant acquiring bank, the merchant service provider, and the payment instrument issuer. Merchant databases as maintained by payment instrument issuers, merchant acquiring banks, and/or payment instrument issuers are often incomplete, and further recent data, such as a merchant's telephone number (as indicated by the destination telephone number the potential payor was in contact with within the window of time when the request for authorization was received) is a valuable addition to the merchant database.

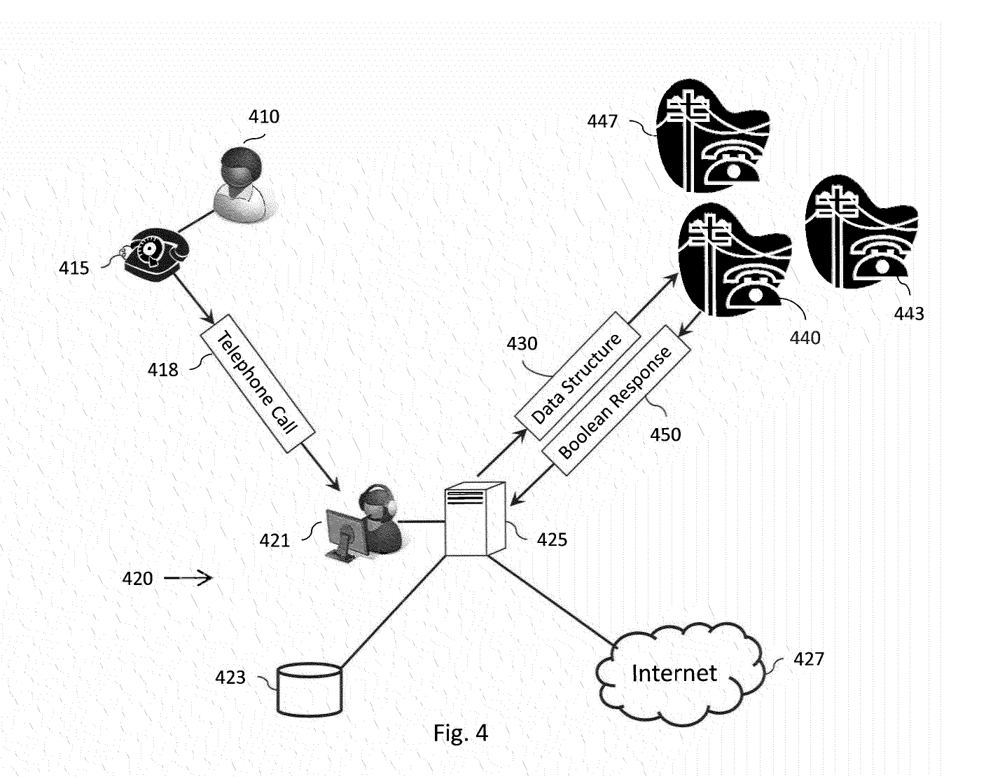

Referring now to FIG. 4, illustrated is a schematic diagram displaying elements utilized in the process of completion of payment transactions in an embodiment of the disclosure. A potential payor who requests authorization of a payment transaction 410 is displayed. The potential payor's telephone 415 is also displayed. In various embodiments of the disclosure, the potential payor's telephone 415 may be a standard telephone, satellite telephone, voice over IP phone, cellular telephone, teletype machine, pager, telecommunications device for the deaf, teletypewriter, or any other presently existing or after arising equivalent allowing completion of a telephone call. The potential payor 410 uses the potential payor's telephone 415 to make a telephone call 418. The telephone call 418 is made for the purpose of seeking authorization for a payment transaction using a payment instrument, or merely a payment instrument identification. In various embodiments of the disclosure, the potential payor 410 may have the payment instrument physically present with him to provide information, such a payment instrument account information during the telephone call 418, or such payment instrument identification is maintained by the call center 420 to allow for quick authorization of payment instrument transactions simply by the potential payor 410 placing a telephone call (as for bill payment, re-occurring orders, or any other telephone orders) to the call center 420. A call center operator 421 receives the telephone call 418. In other embodiments of the disclosure, the call center 420 receives the telephone call 418 via an IVR, automated attended (“AA”) or other computer-implemented manner, allowing further transaction processing to occur automatically. A computing device associated with the call center 425 accesses a system time the telephone call 418 was received, as well as the phone number associated with the potential payor's telephone 415, and stores the telephone number associated with the received telephone call 418 and the time the received telephone call 418 was received in a data structure 430. The computing device 425 then identifies which telephone company 440 of a plurality of telephone companies 440, 443, 447 is associated with the telephone number of the received telephone call 418, and provides telephone service for the telephone call 418. In an embodiment of the disclosure, the computing device 425 accesses the internet 427 to determine which telephone company 440 is associated with the telephone call 418. In other embodiments, the computing device 425 accesses internal storage associated with the computing device 425, a database 423 associated with the call center 420, a remote database (not shown), or even computing devices or databases associated with the telephone companies 440, 443, 447 themselves (not shown), to determine which telephone company 440, 443, 447 is associated with the telephone call 418. Once the telephone company associated with the telephone call 440 is identified among the plurality of telephone companies 440, 443, 447, the computing device 425 transmits a query included the data structure 430 to the telephone company associated with the telephone call 440. The call center 420 then receives a Boolean response 450 from the telephone company associated with the received telephone call 440. Other responses might be received in alternate embodiments. If the Boolean response 450 is true, in an embodiment of the disclosure, the computing device 425 then retrieves a payment instrument identification from one or multiple payment instrument identifications from a computer database 423. In other embodiments of the disclosure, the computing device simply processes the payment instrument identification that the potential payor 410 has provided previously. If the Boolean response 450 is false, the potential payor 410 is informed of the failure to authenticate via the call center operator, IVR, AA, or other equivalent computerized means, presently existing or after-arising.

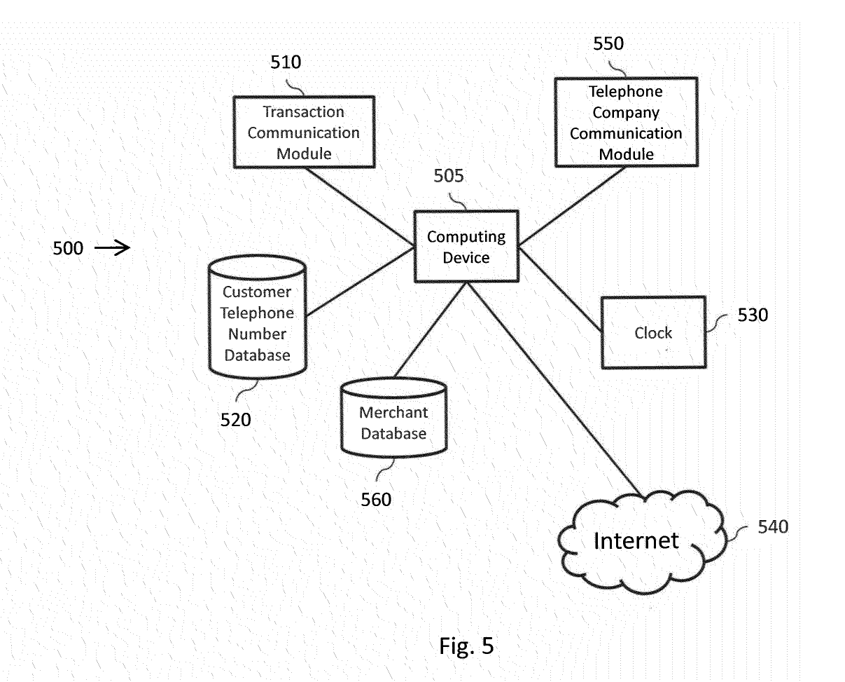

Referring now to FIG. 5, illustrated is a block diagram of a system for authorization of payment instrument transactions 500 in an embodiment of the disclosure. A transaction communication module 510 (implemented in software or hardware) receives a request for authorization of a transaction containing a customer identification number or a payment instrument identification, either uniquely identifying a potential payor attempting to complete a transaction via telephone. The transaction communication module 510 is in communication with, by means of non-limiting example, a merchant, a payment network, or any other individual or organization seeking approval of a payment instrument transaction. The transaction communication module 510 is operatively connected to a computing device 505 associated with the system 500 in an embodiment of the disclosure. In a further embodiment of the disclosure, the computing device 505 then accesses a customer telephone number database 520 to retrieve a customer telephone number associated with the potential payor. In an embodiment of the disclosure, the customer telephone database 520 is maintained locally on a computing device associated with system 500. In alternate embodiments of the disclosure, the customer telephone database 520 is maintained remotely by a separate organization, such as a payment instrument issuer or a payment instrument network (by means of non-limiting example). The computing device 505 then stores the customer telephone number associated with the potential payor and the time the request for authorization of the transaction was received (accessible in a system clock 530) in a data structure (not displayed here) or other computer-implemented storage device. The computing device 505 then identifies which telephone company of a plurality of telephone companies is associated with the customer telephone number (in a manner as discussed previously herein). In an embodiment of the disclosure, a query including the data structure is then transmitted by the computing device to the identified telephone company associated with the customer telephone number via a telephone company communication module 550 (which may also be implemented in hardware or software). The computing device 505 then receives a response from the telephone company via the telephone company communication module 550, including a Boolean response. In the various embodiments of the disclosure, if the Boolean response indicates “true,” or that the potential payor was engaged in an outbound call within a window of time of when the request for authorization was received, a merchant database associating an identification of the merchant with the destination number of the potential payor is updated. This is done because frequently information in a merchant database (as 560) is incomplete, and the destination number the potential payor was in contact with within the window of time of when the request for authorization was received is, in fact, the merchant telephone number. It is useful to track such information for various reasons beyond the scope of the presently disclosed system, method, and computer software product.

The preceding description has been presented only to illustrate and describe the disclosure. It is not intended to be exhaustive or to limit the disclosure to any precise form disclosed. Many modifications and variations are possible in light of the above teachings. Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

As would be appreciated by one of skill in the art, the presently disclosed disclosure will comply with all relevant state, federal, and international laws regarding uses of telecommunications data, data privacy, and all other relevant laws.

The preferred embodiments were chosen and described in order to best explain the principles of the disclosure and its practical application. The preceding description is intended to enable others skilled in the art to best utilize the disclosure in its various embodiments and with various modifications as are suited to the particular use contemplated. It is intended that the scope of the disclosure be defined by the following claims.

What is claimed is:

1. A method of authentication of a payment transaction by a payment instrument via identification of a telephone call received by a call center comprising:
Receiving by said call center a telephone call from a potential payor requesting authorization of a payment transaction by a payment instrument;
Storing by a computing device associated with the call center a telephone number associated with the received telephone call and a time the received telephone call was received at the call center in a data structure;
Identifying by the computing device which telephone company of a plurality of telephone companies is associated with the telephone number of the received telephone call;
Transmitting a query including the data structure by the computing device to the identified telephone company associated with the received telephone call;
Receiving of a Boolean response from the identified telephone company indicating whether or not the telephone number associated with the received telephone call contained in the data structure was engaged in an outbound call at the time the received telephone call was received at the call center;
If said Boolean response from the identified telephone company indicates true, performing the further steps a.-b. of:
a. Retrieving a payment instrument identification of one or multiple payment instrument identifications associated with the potential payor from a computer database; and
b. Allowing authorization of the transaction to proceed;
Else if said Boolean response from the identified telephone company indicates false, performing the further step c. of:
c. Automatically informing the potential payor of a failure to authenticate the transaction.

2. The method of claim 1 wherein if said Boolean response from the telephone company indicates true and if multiple payment instrument identifications are associated with the potential payor, then automatically presenting an option of which payment instrument identification to utilize to the potential payor previous to allowing authorization of the transaction to proceed.

3. The method of claim 2 wherein the option of which payment instrument identification to utilize is presented via an interactive voice menu.

4. The method of claim 1 wherein the payment transaction is a telephone payment or a telephone order.

5. The method of claim 1 wherein said call center is maintained by selectively one of a payment instrument issuer, a merchant acquiring bank, a merchant service provider, a payment instrument network, and a merchant.

6. A method for authorization of payment instrument transactions made via telephone comprising:
Receiving by a payment instrument organization a request for authorization of a transaction containing a customer identification number or a payment instrument identification, either uniquely identifying a potential payor attempting to complete a transaction via telephone;
Accessing a database maintained by the payment instrument organization and retrieving a customer telephone number associated with the potential payor;
Storing by a computing device associated with the payment instrument organization the customer telephone number associated with the potential payor and a time the request for authorization of the transaction was received by the payment instrument organization in a data structure;
Identifying by the computing device which telephone company of a plurality of telephone companies is associated with the customer telephone number;
Transmitting a query including the data structure by the computing device to the identified telephone company associated with the customer telephone number;
Receiving at the computing device a response containing a Boolean response from the identified telephone company indicating whether or not the customer telephone number associated with the potential payor was engaged in an outbound call within a window of the time of when the request for authorization of the transaction was received and, if true, said response further containing a destination number the potential payor was in contact with within the window of the time of when the request for authorization was received;
If said Boolean response from the identified telephone company indicates true, performing the further step a. of:
a. Approving the transaction;
Else if said Boolean response from the identified telephone company indicates false, performing the further step c. of:
c. Denying the transaction.

7. The method of claim 6 wherein said payment instrument organization is selectively one of a payment instrument issuer, a merchant acquiring bank, a merchant service provider, and a payment instrument network.

8. The method of claim 6 wherein if said Boolean indicates true, performing step a. and then further performing step b. of updating a merchant database associating an identification of the merchant with the destination telephone number the potential payor was in contact with within the window of the time of when the request for authorization was received.

9. The method of claim 6 wherein the window of the time of when the request for authorization was received is equivalent to a time period necessary for the payment instrument organization to receive the request for authorization of the transaction from when the potential payor attempts to complete the transaction via telephone.

10. A system of authentication of a transaction by a payment instrument via identification of a telephone call received by a call center, said system comprising:
Said call center receives a telephone call from a potential payor requesting authorization of a payment transaction by a payment instrument;
A computing device associated with the call center stores a telephone number associated with the received telephone call and a time the received telephone call was received at the call center in a data structure;
Said computing device identifies which telephone company of a plurality of telephone companies is associated with the telephone number of the received telephone call and transmits a query including the data structure to the identified telephone company associated with the received telephone call;
Said computing device receives a Boolean response from the identified telephone company indicating whether or not the telephone number associated with the received telephone call contained in the data structure was engaged in an outbound call at the time the received telephone call was received at the call center;
If said computing device determines the Boolean response from the identified telephone company indicates true, the computing device performs the further steps a.-b. of:
a. Retrieving a payment instrument identification of one or multiple payment instrument identifications associated with the potential payor from a computer database; and
b. Allowing authorization of the transaction to proceed;
Else if said computing device determines the Boolean response from the identified telephone company indicates false, the computing device performs the further step c. of:
c. Automatically informing the potential payor of a failure to authenticate the transaction.

11. The system of claim 10 wherein if the computing device determines the Boolean response from the telephone company indicates true and if multiple payment instrument identifications are associated with the potential payor, then automatically presenting an option of which payment instrument identification to utilize to the potential payor previous to allowing authorization of the transaction to proceed.

12. The system of claim 11 wherein the option of which payment instrument identification to utilize is presented via an interactive voice menu.

13. The system of claim 10 wherein the payment transaction is a telephone payment or a telephone order.

14. The system of claim 10 wherein said call center is maintained by selectively one of a payment instrument issuer, a merchant acquiring bank, a merchant service provider, a payment instrument network, and a merchant.

15. A system for authorization of payment instrument transactions made via telephone, said system comprising:
A payment instrument organization receives a request for authorization of a transaction containing a customer identification number or a payment instrument identification, either uniquely identifying a potential payor attempting to complete a transaction via telephone;
A database maintained by the payment instrument organization retrieves a customer telephone number associated with the potential payor;
A computing device associated with the payment instrument organization stores the customer telephone number associated with the potential payor and a time the request for authorization of the transaction was received by the payment instrument organization in a data structure;
The computing device identifies which telephone company of a plurality of telephone companies is associated with the customer telephone number and transmits a query including the data structure to the identified telephone company associated with the customer telephone number;
The computing device receives a response containing a Boolean response from the identified telephone company indicating whether or not the customer telephone number associated with the potential payor was engaged in an outbound call within a window of the time of when the request for authorization of the transaction was received and, if true, said response further containing a destination number the potential payor was in contact with within the window of the time of when the request for authorization was received;
If the computing device determines the Boolean response from the identified telephone company indicates true, performing the further step a. of:
a. Approving the transaction;
Else if the computing device determines the Boolean response from the identified telephone company indicates false, performing the further step c. of
c. Denying the transaction.

16. The system of claim 15 wherein said payment instrument organization is selectively one a payment instrument issuer, a merchant acquiring bank, a merchant service provider, and a payment instrument network.

17. The system of claim 15 wherein if said Boolean indicates true, said computing device performs step a. and further performs step b. of updating a merchant database associating an identification of the merchant with the destination telephone number the potential payor was in contact with within the window of the time of when the request for authorization was received.

18. The system of claim 15 wherein if said Boolean indicates true, said computing device performs step a. and then further performs step b. of updating a merchant database associating an identification of the merchant with the destination telephone number the potential payor was in contact with within the window of the time of when the request for authorization was received.

19. The system of claim 15 wherein if the window of the time of when the request for authorization was received is equivalent to a time period necessary for the payment instrument organization to receive the request for authorization of the transaction from when the potential payor attempts to complete the transaction via telephone.
